(19) United States
(12) Patent Application Publication
(10) Pub. No.: US 2016/0322617 A1
(43) Pub. Date: Nov. 3, 2016

(54) BATTERY PACK

(71) Applicant: SAMSUNG SDI CO., LTD., Yongin-si (KR)

(72) Inventors: Sanghoon BAE, Yongin-si (KR); Somin KIM, Yongin-si (KR)

(21) Appl. No.: 14/987,869

(22) Filed: Jan. 5, 2016

(30) Foreign Application Priority Data
Apr. 28, 2015 (KR) 10-2015-0060081

(51) Int. Cl. H01M 2/12; H01M 2/10

(52) U.S. Cl. CPC H01M 2/12; H01M 2/1241; H01M 2/1077; H01M 2/1022; H01M 2200/20

(57) ABSTRACT

A battery pack, including a battery cell; a case providing an accommodation space in which the battery cell is disposed; inert gas filled in the accommodation space; and a gas inlet/outlet portion in the case, the gas inlet/outlet portion in contact with the accommodation space, the gas inlet/outlet portion being for injecting gas into the accommodation space and discharging gas from the accommodation space.

### CROSS-REFERENCE TO RELATED APPLICATION

Korean Patent Application No. 10-2015-0060081, filed on Apr. 28, 2015, in the Korean Intellectual Property Office, and entitled: “Battery Pack,” is incorporated by reference herein in its entirety.

### BACKGROUND

1. Field

One or more exemplary embodiments relate to a battery pack.

2. Description of the Related Art

Unlike primary batteries, secondary batteries may be rechargeable. Secondary batteries may be used as energy sources of devices such as mobile devices, electric vehicles, hybrid electric vehicles, electric bicycles, and uninterruptible power supplies. Single-cell secondary batteries or multi-cell secondary batteries (secondary battery packs), in which a plurality of battery cells may be electrically connected, may be used according to the types of external devices using the secondary batteries.

### SUMMARY

Embodiments may be realized by a battery pack, including a battery cell; a case providing an accommodation space in which the battery cell is disposed; inert gas filled in the accommodation space; and a gas inlet/outlet portion in the case, the gas inlet/outlet portion in contact with the accommodation space, the gas inlet/outlet portion being for injecting gas into the accommodation space and discharging gas from the accommodation space.

The gas inlet/outlet portion may include a first gas inlet/outlet portion and a second gas inlet/outlet portion at different positions.

The first gas inlet/outlet portion may be in a lower portion of the case; and the second gas inlet/outlet portion may be in an upper portion of the case.

An output terminal electrically connected to the battery cell may be on the upper portion of the case.

The gas inlet/outlet portion may include a gas tube for providing a gas inlet/outlet; and a groove portion surrounding at least a portion of the gas tube.

The groove portion may surround an entirety of the gas tube.

The gas tube may protrude outward from the case.

A protruding end portion of the gas tube may be sealed through a thermal fusing process.

The battery pack may further include a safety vent on a side of the gas tube. If an internal pressure of the accommodation space becomes greater than a set critical point, the safety vent may be fractured.

The safety vent may be a fracture line or groove in the side of the gas tube.

The safety vent may surround an outer circumference of the gas tube.

The gas inlet/outlet portion may include a first gas inlet/outlet portion and a second gas inlet/outlet portion at different positions, and the safety vent may be formed in the first gas inlet/outlet portion.

The first gas inlet/outlet portion may be in a lower portion of the case.

### BRIEF DESCRIPTION OF THE DRAWINGS

Features will become apparent to those of skill in the art by describing in detail exemplary embodiments with reference to the attached drawings in which:

FIG. 1 illustrates a view of a battery pack according to an exemplary embodiment;

FIG. 2 illustrates an exploded perspective view of the battery pack;

FIG. 3 illustrates a cross-sectional view of a case taken along a line in FIG. 2;

FIG. 4 illustrates a schematic view of a process of injecting inert gas;

FIG. 5 illustrates a view of a case according to an exemplary embodiment;

FIG. 6 illustrates a cross-sectional view taken along a line VI-VI in FIG. 5;

FIG. 7 illustrates a schematic view of a process of injecting inert gas;

FIG. 8 illustrates a view of gas inlet/outlet portions according to an exemplary embodiment;

FIG. 9 illustrates a view of a case according to an exemplary embodiment; and

FIG. 10 illustrates an exploded perspective view of a cell assembly illustrated in FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of features may be exaggerated for clarity of illustration. Like reference numerals refer to like elements throughout.

As used herein, the term “and/or” includes any and all combinations of one or more of the associated listed items. Expressions such as “at least one of,” when preceding a list of elements, modify the entire list of elements and do not modify the individual elements of the list.

A battery pack will now be described in detail with reference to the accompanying drawings, in which exemplary embodiments are shown.

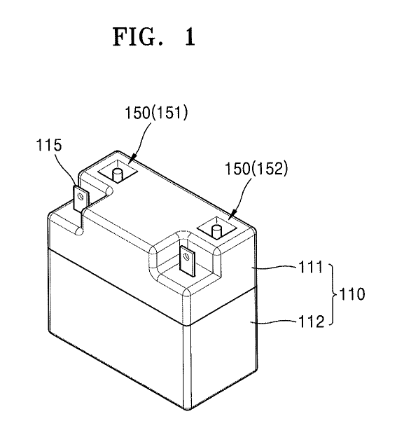

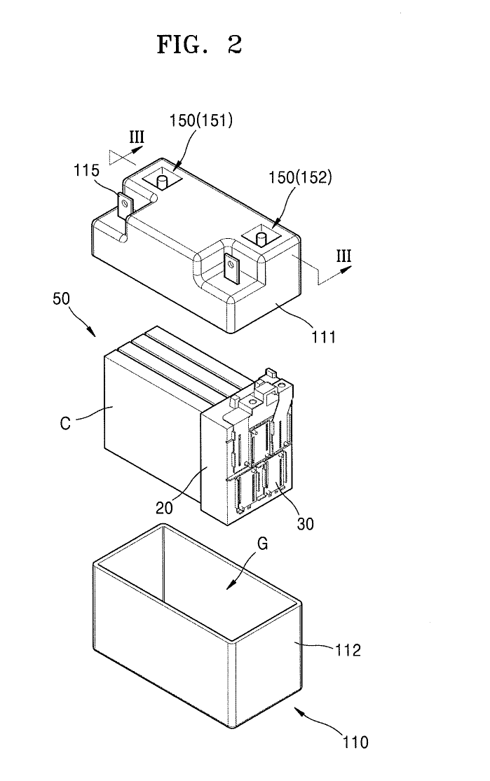

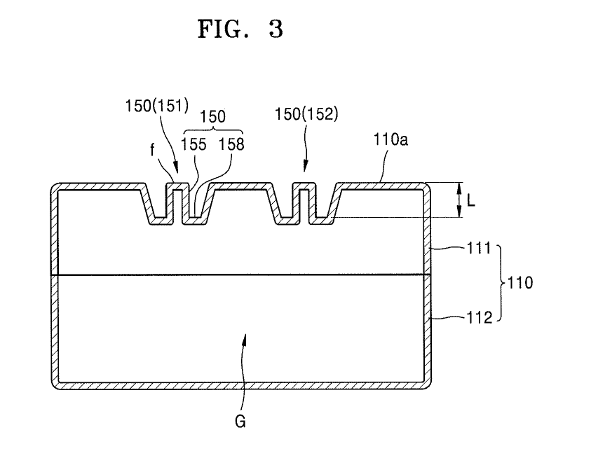

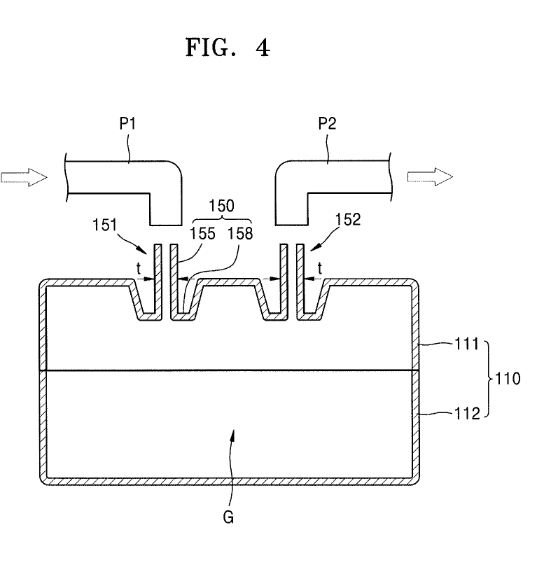

FIG. 1 illustrates a view of a battery pack according to an exemplary embodiment. FIG. 2 illustrates an exploded perspective view of the battery pack. FIG. 3 illustrates a cross-sectional view of a case 110 taken along a line in FIG. 2. FIG. 4 illustrates a schematic view of a process of injecting inert gas.

Referring to FIGS. 1 to 4, the battery pack may include at least two battery cells C, the case 110 forming an accommodation space G in which the battery cells C may be disposed, and gas inlet/outlet portions 150 formed in the case 110 in contact with the accommodation space G. The gas inlet/outlet portions 150 may be used to discharge gas from the accommodation space G and inject gas into the accommodation space G.

The case 110 may accommodate a cell assembly 50 in which the at least two battery cells C may be electrically and structurally coupled to each other. The cell assembly 50 will be described later in more detail.

Output terminals 115 may be formed on the case 110. The output terminals 115 may be formed on the outside of the case 110 in electric connection with the cell assembly 50 accommodated in the case 110. The output terminals 115 may be connected to an external device such as an electric load or a battery charger and may form a charging/discharging current path. The output terminals 115 may include first and second output terminals having different polarities.

The output terminals 115 may be formed on an upper portion of the case 110. For example, the output terminals 115 may be formed on an upper surface of the case 110. Herein, the upper portion of the case 110 may refer to a side of the case 110 on which the output terminals 115 may be formed, and a lower portion of the case 110 may refer to a side of the case 110 opposite the side of the case 110 on which the output terminals 115 may be formed.

The case 110 may include upper and lower cases 111 and 112 coupled to each other in mutually facing directions with the cell assembly 50 being disposed therebetween. For example, the upper surface of the case 110 may refer to an upper surface of the upper case 111, and a lower surface of the case 110 may refer to a lower surface of the lower case 112.

The accommodation space G may be defined by inner walls of the case 110. For example, all the battery cells C may be accommodated in the case 110. The accommodation space G in which the battery cells C may be accommodated may be a non-divided single space, and all the battery cells C disposed in the accommodation space G may be exposed to inert gas filled in, e.g., filling, the accommodation space G.

In the present exemplary embodiment, the inert gas may be filled in the accommodation space G. The inert gas may form an incombustible atmosphere in the accommodation space G in which the battery cells C may be accommodated. An electrochemical reaction may occur in the battery cells C, and the internal pressure of the battery cells C may excessively increase, or accidents such as explosion or fire may occur. If an incombustible atmosphere is formed in the accommodation space G in which the battery cells C may be accommodated, fire or explosion may be prevented even if the battery cells C are in abnormal states such as a high-pressure state or overheated state. If the accommodation space G is not filled with inert gas, air containing oxygen may be filled in the accommodation space G. Oxygen may form a combustion condition in the battery cells C, and the possibility of accidents may increase if the battery cells C are in abnormal states such as a high-pressure state or an overheated state.

In the present exemplary embodiment, the expression “the accommodation space G is filled with inert gas” means that the accommodation space G is filled with inert gas after air is discharged from the accommodation space G. Oxygen may not exist in the accommodation space G, or only a small amount of oxygen may exist in the accommodation space G, and the battery cells C may be prevented from catching on fire.

The gas inlet/outlet portions 150 may be formed in the case 110 in contact with the accommodation space G to discharge gas from the accommodation space G and supply gas to the accommodation space G therethrough. The expression “the gas inlet/outlet portions 150 are in contact with the accommodation space G” means that the gas inlet/outlet portions 150 are directly connected to the accommodation space G, and the accommodation space G may be accessible through the gas inlet/outlet portions 150.

The gas inlet/outlet portions 150 may include a first gas inlet/outlet portion 151 and a second gas inlet/outlet portion 152 that may be formed at different positions. For example, the first gas inlet/outlet portion 151 may function as a gas inlet path, and the second gas inlet/outlet portion 152 may function as a gas discharge path.

The first and second gas inlet/outlet portions 151 and 152 may be formed at different positions, and an inert gas may be injected into the accommodation space G while air may be discharged from the accommodation space G. When the battery pack is manufactured, gas discharge and gas injection may be simultaneously carried out, and for this, the first and second gas inlet/outlet portions 151 and 152 may be formed at different positions in the case 110.

Referring to FIG. 4, a first gas conduit P1 may be connected to the first gas inlet/outlet portion 151 for injecting gas into the accommodation space G. At this time, a fluid pump may be connected to the first gas conduit P1 for applying a positive pressure to the first gas conduit P1. A second gas conduit P2 may be connected to the second gas inlet/outlet portion 152 for discharging gas from the accommodation space G. At this time, a fluid pump may be connected to the second gas conduit P2 for applying a negative pressure to the second gas conduit P2.

In the present exemplary embodiment, the first and second gas inlet/outlet portions 151 and 152 may be formed in the upper portion of the case 110. For example, the first and second gas inlet/outlet portions 151 and 152 may be formed in the upper surface of the case 110 at left and right positions separate from each other. As described later, the first and second gas inlet/outlet portions 151 and 152 may be formed at different heights according to the kind of gas to be injected into the accommodation space G through the first gas inlet/outlet portion 151 and the kind of gas to be discharged from the accommodation space G through the second gas inlet/outlet portion 152.

Referring to FIG. 3, each of the gas inlet/outlet portions 150 may include: a gas tube 155 protruding outward from the case 110; and a groove portion 158 surrounding at least a portion of the gas tube 155. The gas tube 155 may be shaped like a hollow pipe for injecting inert gas into the accommodation space G or discharging air from the accommodation space G through the gas tube 155.

The groove portion 158 may be formed around the gas tube 155 to surround at least a portion of the gas tube 155. For example, the groove portion 158 may surround the entirety of the gas tube 155, e.g., the groove portion 158 may wholly surround the gas tube 155. The gas tube 155 may protrude from the case 110. The expression “the gas tube 155 protrudes from the case 110” means that the gas tube 155 protrudes from a portion of the case 110 surrounding the gas tube 155. The gas tube 155 may not protrude from an outermost surface (uppermost or lowermost surface) 110a of the case 110. As described later, according to the present exemplary embodiment, the gas tube 155 may be formed inside the groove portion 158. The gas tube 155 may protrude from the groove portion 158 but may not protrude from the outermost surface 110a of the case 110.

The gas tube 155 may protrude from the case 110 (by a length L), and a gas conduit (e.g., the first gas conduit P1 or the second gas conduit P2 shown in FIG. 4) may be firmly coupled to the gas tube 155. The gas tube 155 may have the same shape as the shape of the first gas conduit P1 or the second gas conduit P2 used to inject an inert gas into the accommodation space G or discharge gas from the accommodation space G, and may be fitted into or around the first gas conduit P1 or the second gas conduit P2.

A protruding end portion of the gas tube 155, for example, an end portion of the gas tube 155 opposite the case 110, may be sealed through a thermal fusing process. A thermally fused portion (f) may be formed on the end of the gas tube 155. The gas tube 155 may be sealed after gas is injected or discharged through the gas tube 155. If the gas tube 155 is left open, inert gas filled in the accommodation space G may leak through the gas tube 155, and gas containing oxygen may permeate into the accommodation space G. For example, the accommodation space G may not be maintained to have an incombustible atmosphere.

The gas tube 155 may be sealed with an additional sealing member. For example, a sealing member such as a cap may be fitted to the end portion of the gas tube 155. In the present exemplary embodiment, the gas tube 155 may be sealed by fusing the gas tube 155 without using an additional sealing member. Referring to FIG. 4, an additional sealing member may not be used to seal the gas tube 155. Instead, after injecting or discharging gas through the gas tube 155, the gas tube 155 may be heated at a certain position (t) in the length direction of the gas tube 155 by using a torch, and the gas tube 155 may be fused and the end portion of the gas tube 155 may be closed. A thermally fused portion (f) may be formed on the protruding end portion of the gas tube 155, and the gas tube 155 may be closed. The other end portion of the gas tube 155 connected to the case 110 may be opened to the accommodation space G.

The gas tube 155 may be formed of a thermally fusible material, and the gas tube 155 may be sealed through a thermal fusing process. For example, the gas tube 155 may be formed of a polymer.

The groove portion 158 may be formed to maintain the protruding length L of the gas tube 155 while preventing the protruding end portion of the gas tube 155 from excessively protruding from the outermost surface 110a of the case 110. The groove portion 158 may be formed by inwardly recessing the case 110 to guarantee the protruding length L of the gas tube 155. The protruding length L of the gas tube 155 may be a length measured from the bottom of the groove portion 158. If the groove portion 158 is not formed and the gas tube 155 protrudes from the outermost surface (flat surface) 110a of the case 110, the protruding length L of the gas tube 155 from the outermost surface 110a of the case 110 may be excessively large. In the present exemplary embodiment, however, the groove portion 158 may be formed around the gas tube 155. The gas tube 155 may have a sufficiently protruding length L for maintaining stable connection with a gas conduit (the first gas conduit P1 or the second gas conduit P2), but the gas tube 155 may not excessively protrude from the outermost surface 110a of the case 110 because the gas tube 155 may be formed inside the groove portion 158.

In the present exemplary embodiment, the groove portion 158 may surround the entirety of the gas tube 155. The gas tube 155 may be isolated like an island by the groove portion 158. In an exemplary embodiment, however, the groove portion 158 may surround a portion of the gas tube 155. The shape of the groove portion 158 may be variously varied according to the shape of a gas conduit (the first gas conduit P1 or the second gas conduit P2) to be coupled with the gas tube 155.

In an exemplary embodiment, the first and second gas inlet/outlet portions 151 and 152 may be formed at different heights. The first and second gas inlet/outlet portions 151 and 152 may be formed at different heights according to the kind of gas to be injected into the accommodation space G through the first gas inlet/outlet portion 151 and the kind of gas to be discharged from the accommodation space G through the second gas inlet/outlet portion 152, and the gas injection and discharge efficiency of the battery pack may be increased.

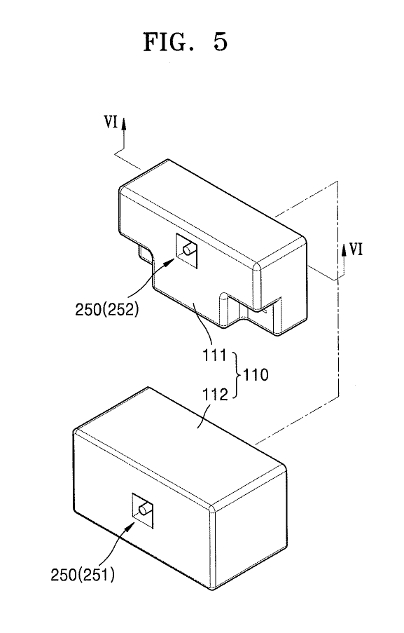

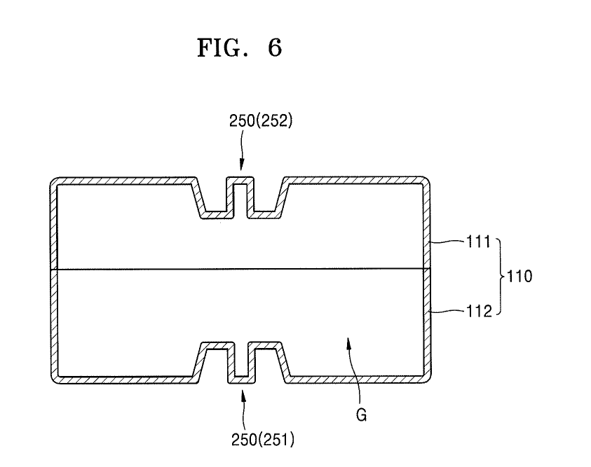

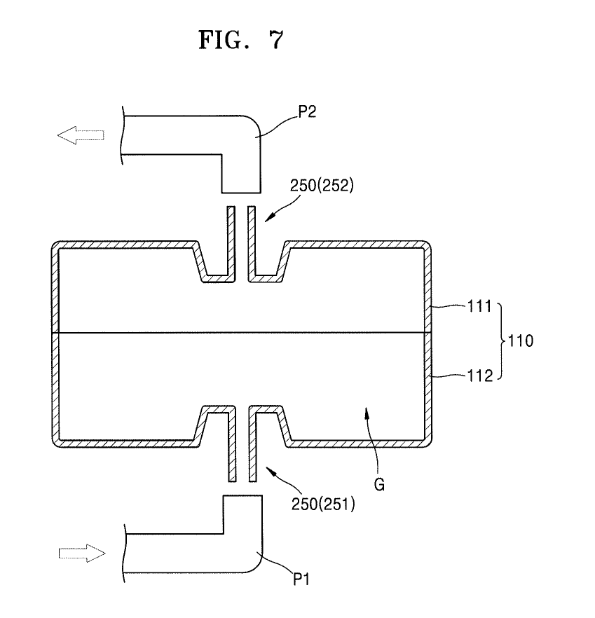

FIG. 5 illustrates a view of a case 110 according to an exemplary embodiment. FIG. 6 illustrates a cross-sectional view taken along a line VI-VI in FIG. 5. FIG. 7 illustrates a schematic view of a process of injecting inert gas.

Referring to FIGS. 5 to 7, gas inlet/outlet portions 250 may be formed in the case 110, and the gas inlet/outlet portions 250 may include a first gas inlet/outlet portion 251 and a second gas inlet/outlet portion 252 that may be formed at different heights. The first gas inlet/outlet portion 251 may be formed in a lower portion of the case 110, for example, a lower surface of the case 110, and inert gas may be supplied through the first gas inlet/outlet portion 251. The second gas inlet/outlet portion 252 may be formed in an upper portion of the case 110, for example, an upper surface of the case 110, and gas may be discharged through the second gas inlet/outlet portion 252. This will now be described in more detail.

When inert gas such as nitrogen gas that is lighter than air is injected into an accommodation space G of the case 110, the inert gas may be injected upward through a lower portion of the case 110 for improving injection efficiency. For this reason, the first gas inlet/outlet portion 251 for supplying an inert gas may be formed in the lower portion of the case 110, for example, the lower surface of the case 110.

Inert gas such as nitrogen gas injected through the lower portion of the case 110 may smoothly fill the inside of the case 110 while flowing upward by the effect of buoyancy. At this time, the inert gas injected into the accommodation space G may lift air filled in the accommodation space G, and if air filled in the accommodation space G is discharged through the upper portion of the case 110, the air may be efficiently discharged. Therefore, the second gas inlet/outlet portion 252 for discharging air may be formed in the upper portion of the case 110, for example, the upper surface of the case 110. Referring to FIG. 7, a first gas conduit P1 may be used to inject an inert gas into the case 110, and a second gas conduit P2 may be used to discharge air from the inside of the case 110.

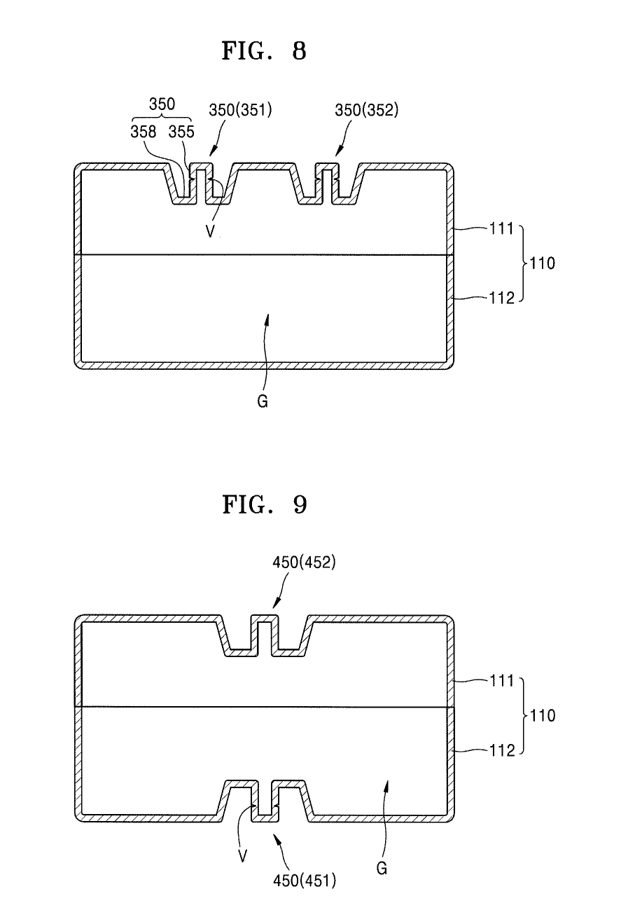

FIG. 8 illustrates a view of gas inlet/outlet portions 350 according to an exemplary embodiment.

Referring to FIG. 8, each of the gas inlet/outlet portions 350 may include: a gas tube 355 protruding outward from a case 110; and a groove portion 358 surrounding at least a portion of the gas tube 355. A safety vent V may be formed in a side of the gas tube 355. If the internal pressure of the case 110 increases to be greater than a set critical point, the safety vent V may be fractured to release the internal pressure of the case 110. For example, the safety vent V may be formed in a side of the gas tube 355 in the form of a fracture line or a fracture groove. The term “fracture line or fracture groove” refers to a structure at which the gas tube 355 will be surely fractured if the internal pressure of the case 110 increases to be greater than a preset critical point. For example, the fracture line or fracture groove may be formed by decreasing the thickness of a local portion of the gas tube 355 so as to induce a fracture of the gas tube 355 at the fracture line or fracture groove. Practically, the terms “fracture line” and “fracture groove” may be interchangeably used to refer to the same structure.

The safety vent V may surround the outer circumference of the gas tube 355. For example, the safety vent V may be a fracture line or a fracture groove surrounding the outer circumference of the gas tube 355. An accommodation space G of the case 110 may be maintained at the same pressure as the internal pressure of the gas tube 355 because the inside of the gas tube 355 is opened to the accommodation space G. If the pressure of the accommodation space G exceeds a proper level, the gas tube 355 may be fractured along the fracture line or groove, and the accommodation space G may be opened to the outside of the case 110.

In the present exemplary embodiment, the safety vent V may be formed in the case 110, and if the pressure of the accommodation space G excessively increases, the safety vent V may be fractured to release the pressure of the accommodation space G. The safety vent V may be formed as part of the gas tube 355, and it may not be necessary to add an additional structure for forming the safety vent V.

FIG. 9 illustrates a view of a case 110 according to an exemplary embodiment.

Referring to FIG. 9, gas inlet/outlet portions 450 may include a first gas inlet/outlet portion 451 and a second gas inlet/outlet portion that may be formed at different positions, and a safety vent V may be formed in one of the first and second gas inlet/outlet portions 451 and 452, for example, in the first gas inlet/outlet portion 451.

If the safety vent V is fractured in response to an event such as an increase in pressure, safety may be guaranteed. For example, it may not be necessary to form a plurality of safety vents V. Safety may be guaranteed by forming only a single safety vent. The safety vent V may be selectively formed in only one of the gas inlet/outlet portions 450.

The safety vent V may provide a path through which high-temperature, high-pressure gas may be discharged in an emergency situation, and the safety vent V may be formed in the first gas inlet/outlet portion 451 formed in a lower portion of the case 110. For example, the battery pack may be installed in a vehicle as a main or auxiliary power source. If the safety vent V is formed in an upper surface of the case 110, for example, in the second gas inlet/outlet portion 452 formed in an upper portion of the case 110, high-temperature, high-pressure gas may be discharged toward a driver or passenger.

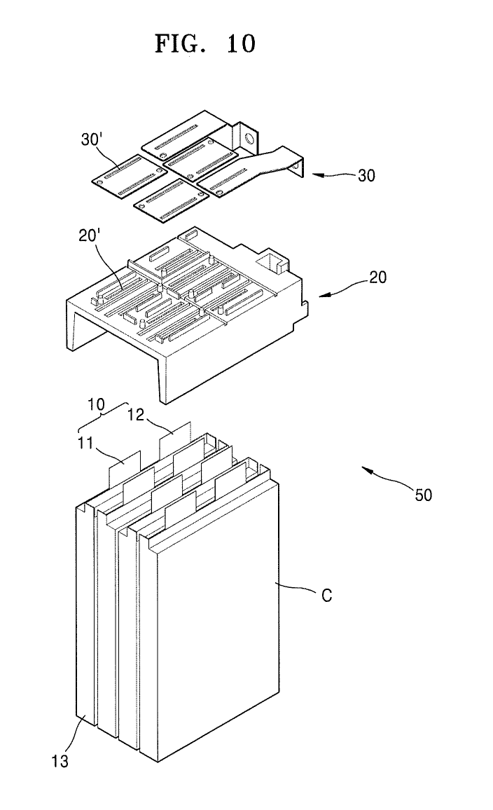

FIG. 10 illustrates a view of the cell assembly 50 illustrated in FIG. 2. In FIG. 10, for clarity of description, the cell assembly 50 is rotated by 90 degrees compared to the orientation of the cell assembly 50 shown in FIG. 2.

Referring to FIG. 10, the cell assembly 50 may include at least two battery cells C and a cell holder 20 to which the battery cells C may be coupled. The battery cells C may include lithium-ion battery cells. Each of the battery cells C may include an electrode assembly having a stacked structure formed by first and second electrode plates having different polarities and a separator disposed between the first and second electrode plates. A plurality of first and second electrode plates and a plurality of separators may be stacked in the electrode assembly to increase the output power and capacity of the battery cell C.

The battery cells C may include covers 13 to seal the electrode assemblies. The battery cells C may be pouch type battery cells including relatively flexible covers 13 instead of relatively hard metal cans. Each of the battery cells C may include electrode tabs 10 electrically connected to the electrode assemblies and extending outward from the covers 13. Each of the battery cells C may include first and second electrode tabs 11 and 12 respectively making electrical connection with the first and second electrode plates and having different polarities.

The battery cells C may be coupled to the cell holder 20. For example, the battery cells C may be coupled to the cell holder 20 in such a manner that the electrode tabs 10 of the battery cells C may be exposed at an upper surface of the cell holder 20. The cell holder 20 may support and hold the battery cells C, and the battery cells C may be maintained at proper positions after being inserted into the cell holder 20. The cell holder 20 may structurally combine the battery cells C as a single module.

The cell holder 20 may include a plurality of tab holes 20′ corresponding to the battery cells C. The electrode tabs 10 extending from the battery cells C may be inserted through the tab holes 20′ and exposed to the outside. The tab holes 20′ may be paired such that the first and second electrode tabs 11 and 12 extending from each of the battery cells C may be inserted through a pair of the tab holes 20′. For example, the first and second electrode tabs 11 and 12 extending from one of the battery cells C may be inserted through a pair of the tab holes 20′, and then the first and second electrode tabs 11 and 12 may be bent forward and backward in opposite directions to make electrical connection with neighboring battery cells C disposed in front and rear directions.

The battery cells C neighboring each other in a front-to-rear direction may be electrically connected to each other through connection tabs 30 superposed on the first and second electrode tabs 11 and 12 of the battery cells C. For example, the battery cells C arranged in the front-to-rear direction may be structurally modularized by the cell holder 20 and then may be electrically modularized by the connection tabs 30.

The electrode tabs 10 extending from the cell holder 20 through the tab holes 20′ may be inserted into the connection tabs 30. For example, the electrode tabs 10 may be inserted through the tab holes 20′ of the cell holder 20 and tab holes 30′ of the connection tabs 30 and may then be exposed at an upper surface of the connection tabs 30. The electrode tabs 10 may be coupled to the connection tabs 30, for example, by welding.

The battery cells C may be electrically connected in series, parallel, or series-parallel through the connection tabs 30. Connection tabs 30 disposed at both ends of an electricity path of the battery cells C connected to each other may be connected to the output terminals 115 (refer to FIG. 2) formed on the outside of the case 110 through output wires.

As described above, according to the one or more of the above exemplary embodiments, inert gas may be injected into the accommodation space G in which the battery cells C may be disposed, and the battery cells C of the battery pack may be prevented from exploding or catching on fire.

The battery pack may have an improved gas discharge and injection structure, and gas filled in the accommodation space G in which the battery cells C may be disposed may be easily discharged and inert gas may be easily injected into the accommodation space G.

By way of summation and review, one or more exemplary embodiments include a battery pack that may be configured to prevent explosion or catching on fire by filling inert gas in an accommodation space of the battery pack in which battery cells may be disposed.

One or more exemplary embodiments include a battery pack that may have an improved gas discharge and injection structure for easily discharging gas filled in an accommodation space of the battery pack in which battery cells may be disposed, and easily injecting inert gas into the accommodation space.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a battery cell;
a case providing an accommodation space in which the battery cell is disposed;
inert gas filled in the accommodation space; and
a gas inlet/outlet portion in the case, the gas inlet/outlet portion in contact with the accommodation space, the gas inlet/outlet portion being for injecting gas into the accommodation space and discharging gas from the accommodation space.

2. The battery pack as claimed in claim 1, wherein the gas inlet/outlet portion includes a first gas inlet/outlet portion and a second gas inlet/outlet portion at different positions.

3. The battery pack as claimed in claim 2, wherein:
the first gas inlet/outlet portion is in a lower portion of the case; and
the second gas inlet/outlet portion is in an upper portion of the case.

4. The battery pack as claimed in claim 3, wherein an output terminal electrically connected to the battery cell is on the upper portion of the case.

5. The battery pack as claimed in claim 1, wherein the gas inlet/outlet portion includes:
a gas tube for providing a gas inlet/outlet; and
a groove portion surrounding at least a portion of the gas tube.

6. The battery pack as claimed in claim 5, wherein the groove portion surrounds an entirety of the gas tube.

7. The battery pack as claimed in claim 5, wherein the gas tube protrudes outward from the case.

8. The battery pack as claimed in claim 7, wherein a protruding end portion of the gas tube is sealed through a thermal fusing process.

9. The battery pack as claimed in claim 5, further comprising a safety vent on a side of the gas tube, wherein if an internal pressure of the accommodation space becomes greater than a set critical point, the safety vent is fractured.

10. The battery pack as claimed in claim 9, wherein the safety vent is a fracture line or groove in the side of the gas tube.

11. The battery pack as claimed in claim 9, wherein the safety vent surrounds an outer circumference of the gas tube.

12. The battery pack as claimed in claim 9, wherein:
the gas inlet/outlet portion includes a first gas inlet/outlet portion and a second gas inlet/outlet portion at different positions, and
the safety vent is formed in the first gas inlet/outlet portion.

13. The battery pack as claimed in claim 12, wherein the first gas inlet/outlet portion is in a lower portion of the case.
